(19) United States
(12) Patent Application Publication
(10) Pub. No.: US 2007/0292830 A1
(43) Pub. Date: Dec. 20, 2007

(54) Collection of models for facilitating the study of at least one of a biological subject, an anatomical organ and an anatomical organ system of a living being

(75) Inventors: Maria Das Gracas Ribeiro, Funcionarios - Belo Horizonte - MG (BR); Valeria De Cassia Resende Graciano, Ouro Preto - Belo Horizonte - MG (BR); Junea Mara Goncalves Moraes De Castro, Ouro Preto - Belo Horizonte - MG (BR); Christiane De Fatima Tavares, Nossa Senhora das Gracas Sete Lagoas (BR); Daniele Sirineu Pereira, Centro - Belo Horizonte - MG (BR); Tatiana Pessoa Da Silva Pinto, Belo Horizonte (BR)

Correspondence Address: NIXON & VANDERHYE, PC, 901 NORTH GLEBE ROAD, 11TH FLOOR, ARLINGTON, VA, 22203, US

(73) Assignee: UNIVERSIDADE FEDERAL DE MINAS GERAIS, Belo Horizonte (BR)

(21) Appl. No.: 11/892,066

(22) Filed: Aug. 20, 2007

Related U.S. Application Data
(63) Continuation-in-part of application No. 10/576,874, filed on May 1, 2007.

(30) Foreign Application Priority Data
Oct. 22, 2003 (BR) PI 0305646-5

(51) Int. Cl. G09B 23/28

(52) U.S. Cl. 434/295

(57) ABSTRACT

The collection of 41 three-dimensional products, 11 raised products, and a process of didactic interpretation in printed form and in Braille aim at the educational inclusion and improvement of the teaching-learning process of Morphological Sciences, in general, and especially for the visually handicapped, facilitating the association of theoretical concepts to the perception of the form, dimension, topography and proportions of the organic structures being studied.

This application is a Continuation In Part of application Ser. No. 10/576,874 filed Apr. 21, 2006, which is a US National Phase of International Application No. PCT/BR2004/000206 filed Oct. 21, 2004, which designated the U.S. and claims benefit of PI 0305646-5, filed Oct. 22, 2003, the entire contents of each of which are hereby incorporated by reference.

### BACKGROUND OF THE INVENTION

It is well-known that visual handicap is a reality for thousands of citizens throughout the world. On Sep. 14, 2001, the guiding principles proposed by the Inter-American Convention came into force in Brazil, determining the Elimination of All Forms of Discrimination Against Handicapped People (Legislative Decree No. 198). However, although the Brazilian Constitution guarantees people with special learning needs the right to enjoy all the rights of the common citizen, the visually handicapped have found little opportunity even when it has been a question of their basic education.

With respect to basic and intermediate instruction, these citizens can count on very few specialized centers that will guarantee them a formal education.

There are countless institutions that, even while struggling to implement quality instruction, have neither the resources nor the specialized teaching tools to meet the general and specific requirements of these students, most of which have not been able to engage in inclusive activities.

In higher education, this situation is even more serious, for in spite of the “democratic” selection process, which also offers opportunities to those with special educational needs to enter colleges and universities, access to one of these institutions is a nearly impossible dream for many of these students, whose greatest struggle is still for a basic education of quality. Even more surprising is the fact that the visually handicapped enter a university and do not find what they require for their professional training, such as bibliographies in Braille, adequate material for their practical classes, suitable workshops and/or laboratories and trained teachers.

The absence of specialized materials makes the learning process even more limiting when it comes to the study of human morphology. Morphology involves the study of the individual constitution, including contents from anatomy, cytology, histology, and embryology. The teaching of these subjects is essentially practical, requiring teaching resources such as photomicrographs, histological slides, and anatomical pieces, all of which are visual resources, which prevents the visually handicapped from using them. Their learning has been based on listening to cassette tapes recorded by relatives or helpers of good will, since a collection of biological products covering all the areas of human morphology—cells, tissues, organs (isolated and/or incorporated in systems), embryos and fetuses, specifically intended for the special needs of these individuals still does not exist on the market, as attested by bibliographical research and investigations of patent banks.

The absence of these didactic resources necessary for learning has the effect of restricting the right of the visually handicapped to quality instruction, the access to information, and the scientific and technological development in this area. These limitations, in effect, lead to difficulties in school and to educational exclusion of these individuals, and may also culminate in obstacles to their professional qualification and insertion in the job market. At present, only in some schools of higher education are three-dimensional pieces, made of resin, used for the study of human embryology and macroscopic anatomy. There are, however, restrictions regarding their use for the visually handicapped, since they are not specific to needs such as: the possibility of handling and manually exploring the cells, tissues, and organs; variation in the size of the pieces for better understanding of the structures under study; pieces that can be disassembled and reassembled, according to the functional study of the structure.

### SUMMARY OF THE INVENTION

The objects of the present invention are the training of specialized teachers and the improvement of teaching and learning processes for the visually handicapped in basic, intermediate, and higher education, making classes and/or practical activities in cytology, histology, anatomy, and embryology more dynamic and interactive, as well as improving the teacher-student relationship and the relation of the student with the objects of study, both in the classroom and in science centers, museums, and other places that provide informal education.

According to the present invention there is provided a collection of models for facilitating the study of at least one of a biological subject, an anatomical organ and an anatomical organ system of a living being by students both with and without visual impairments;

(a) at least one base for supporting at least one model structure;

(b) at least one scientific or technical structure model to be studied as a whole by students both with and without visual impairments;

(c) at least one substructure model of a plurality of individual and optionally separable substructure models, which may be movably arranged with respect to one another in accordance with the corresponding relationship between each said substructure model and said structure model as and/or between said substructure models;

(d) an interpretative set for said models for facilitating the formation of images from an associative and enduring learning skills method by students both with and without visual impairments

In the preferred embodiment the collection comprises a total of 51 biological models of which are 42 are three-dimensional and 9 are in relief. Also in the preferred embodiment, the interpretive set comprises a first part in the form of a both printed and Braille informative description comprising a classical scientific and technological approach, and a second part which comprises a detailed description in both printed and Braille form of each structure model or substructure models and the relationship between each said substructure model and said structure model and/or between said substructure models.

The three-dimensional products and products in relief, as well as the interpretative process, facilitate the association of theoretical concepts with the perception of form, dimension, topography, and proportion of the structures being studied. In this way, students with special educational needs and principally the visually handicapped are capable of recognizing and differentiating the cellular, histological, anatomical, and embryonic structures, through the use of textures and dimensions suitable for consideration of each piece or model created which contributes to their identification. Such recognition facilitates correlation between morphological and physiological aspects when handling each model. They are also capable of understanding, on the basis of previous study, the relation between the location of each structure and the various functions performed by the organism, including the different levels of organization of the human body. Consideration must be given to accompanying teaching tools that facilitate understanding, such as a guiding process for the use of the products, such as explanatory legends, audio-books, guide books in written or Braille form, with orientation for topographical exploration (forms, textures, raised or sunken parts, dimensions), the purpose of which is to guide the hands of the student over the piece and by means of which he becomes independent of others to study and learn the theoretical and practical contents covered, he further being able to use audition as a facilitator in his learning.

The invention is based on the need for teaching resources for the visually handicapped, with respect to the study of morphology, keeping in mind their special needs of learning through touch. To this end the three dimensional biological products and biological products in relief reproduce the structure of cells, cellular parts, tissues, phases of embryonic and fetal development, and organs, portraying the human body as closely as possible to what it actually looks like. Each product has specific characteristics that permit identification of its structures, such as that of the plasmatic membrane and of each cell part; of each tissue with its various types of cell (columnar, triangular, calceiform, with lashes or other microscopic characteristics); of each organ represented longitudinal or transverse section, with texturized details that permit, through touch, differentiate between the tissues of which it is composed, relating them to the function that each exerts and making it easier for the visually handicapped student to learn through association. Some organs, apart from being almost life-size, have also been reproduced in considerably enlarged dimensions so as to permit perception of microscopic details of their structures which was previously very difficult for such students. The representation of each organic system in isolation from the others permits a visually handicapped student not only to identify each organ by touch, but also to perceive its inter-relationships with the other different components of each system. The specifics of each product directly meet the needs of the visually handicapped

All the products of the collection were minutely tested with the targeted public (the visually handicapped) for the purpose of finding a convergence between product production issues and the needs and expectations of that public. The response given by the visually handicapped in their use of these products showed their fundamental importance, for by means of the response various adaptations were made, until each product, as well as the interpretative process, corresponded to the specific needs of these individuals.

A fundamental component for the success of the present invention was the choice of materials appropriate to the manufacture of the products described herein. In the course of the experiments, various materials were tested, and several factors, such as practicality, plasticity, and durability were considered, and the most adequate for the required detail, for handling, production and reproduction were chosen.

The products can be modeled in any moldable material, preferably in clay. The choice of this material was based on the fact that it is a very plastic material, allowing a great variety of textures and contours. The use of clay is also advantageous, as it allows several adaptations of textures to be made after experimental use with the visually handicapped, even when the products are already in the final phase. At the end of the clay modeling process, the products are fired in a specific oven. The aim of the firing is for the products to acquire resistance for future reproduction. With the conclusion of the stages of modeling, firing, and form production, the next step is the reproduction of the products in a definitive material; and plaster has been found to be advantageous and economically viable for three-dimensional models. Among the proven advantages, strength is essential since the visually handicapped sometimes need to use a firmer grip better to explore the pieces, which will be constantly handled, requiring greater strength and durability. The last part of the process of manufacturing the three-dimensional products consists of their being painted different colors to differentiate each structure. For models in relief, the choice of material also follows criteria such as durability and strength. With respect to relief work, the criterion is to chose a material that provides sufficient strength and sufficient relief to permit a tactile perception of the structures by the visually handicapped.

The painting of the products is to make them more attractive to the students who can see, with the aim of including everyone in the learning process, further facilitating memorization by a process of association (each epithelial is yellow, each connective tissue is pink). The choice of colors is therefore made according to didactic criteria for the three-dimensional cytological, histological and embryological models. For the three-dimensional anatomical models representing the different organs, colors as close as possible to those of the real organs are to be used. For cytological and histological relief models, a neutral color, such a beige, is used.

The interpretative orientation which features as a part of the present invention, represent one of the important differentials of the collection and is characterized as a theoretical-practical guide, the purpose of which is to orient the study of subject matter of the different areas of morphology, consists of two parts: the first describes the theoretical content, and the second describes each product of the collection. It is important to note that, in the first part, besides the classical approach t cytology, histology, anatomy, and embryology, there is also basic information of the physiology of the structures studied, which enriches the interdisciplinary approach. In the second part, the products are described in detail, with legends that accompany each piece. The purpose of the description of the products is to guide the hands of the visually handicapped over the product, making it easier for them to associate the basic content with the three-dimensional representation of the structures under study, whereby, according to their own testimony, “ . . . the formation of images that will make learning easier and more lasting” is made possible.

### BRIEF DESCRIPTION OF THE DRAWINGS

The invention described herein is additionally illustrated by means of the attached drawings which show the morphological models that make up the collection and in which:

FIGS. 1 to 42 illustrate three-dimensional models relating to the human body, many of greatly enlarged microscopic structures, and others which are approximately life-size; and

FIGS. 43 to 51 show basically planar relief models.

### DETAILED DESCRIPTION OF THE DRAWINGS

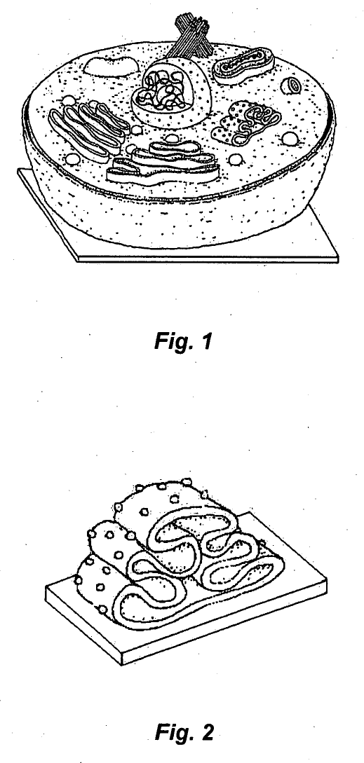

FIG. 1 is a sectional showing of a greatly enlarged model representing a cell in the form of a sphere, that permits the tactile perception of the arrangement of its organelles which project from the cytoplasm, some of which represent a section above the level of the section of the cell so as to allow one to distinguish between the rough endoplasmic reticulum, the smooth endoplasmic reticulum, the Golgi body, complete mitochondria and mitochondria in section, lysosome, centrioles and the cell nucleus, the dimensions of which, in the present case, are not proportional with respect to each other. The criterion adopted for their sizes in this model being the necessity of the blind student to recognize each of them by touch. The cytoplasm is represented by a resin surface and the cell membrane surrounding it is mad eof silicon which is softer and of a different texture. The cell is supported on a metal tripod to permit the visually handicapped to run their hands over (feel) the whole model, thus facilitating recognition of its shape.

FIG. 2 is an illustration of an enlarged model representing a section of the rough endoplasmic reticulum, a smooth surface membranous organelle of which the spheres on its outer wall possess ribosomes attached to its outer membrane. The model is supported on a wooden base;

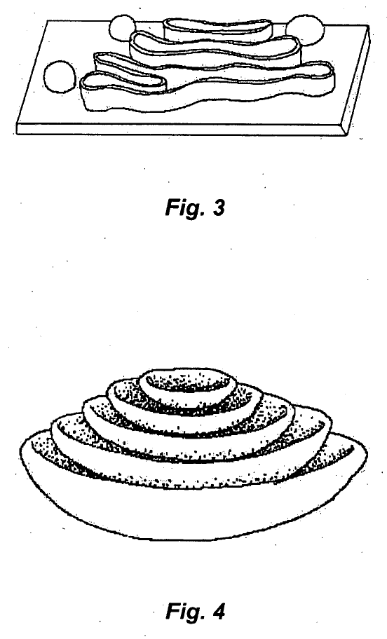

FIG. 3 is an illustration of an enlarged model representing a cross section of the smooth endoplasmic reticulum, a smooth walled membranous organelle. The model is supported on a wooden base.

FIG. 4 is an illustration of an enlarged model of a model representing a Golgi body, a cellular organelle consisting of structures similar to stacked plates. It is supported on a wooden base.

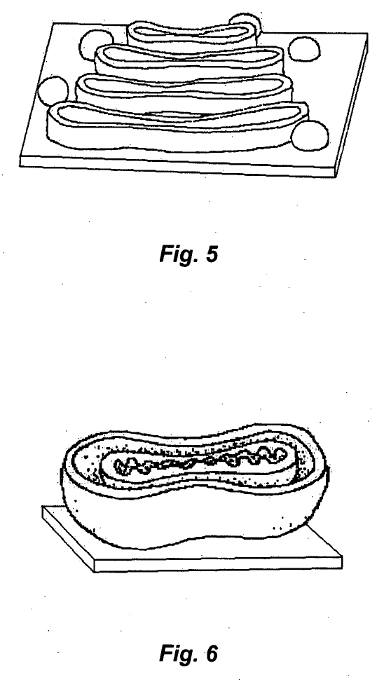

FIG. 5 is an illustration of an enlarged model representing a cross section of a Golgi body with its cisternae (inner space) that may be perceived by touch. The model is supported on a wooden base.

FIG. 6 is a longitudinal section of an enlarged model representing a “closed” mitochondrion to expose the pleated inner membrane (with cristae). The model is supported on a wooden base.

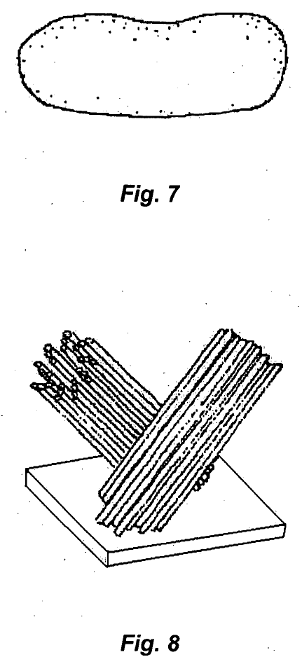

FIG. 7 is an illustration of the enlarged model of the model representing a “closed” mitochondrion, an elongated organelle having a smooth outer surface. The model is supported on a wooden base, exposing the ruffled internal membrane.

FIG. 8 is an illustration of an enlarged model representing a pair of centrioles composed of nine microtubule triplets. The model is supported on a wooden base.

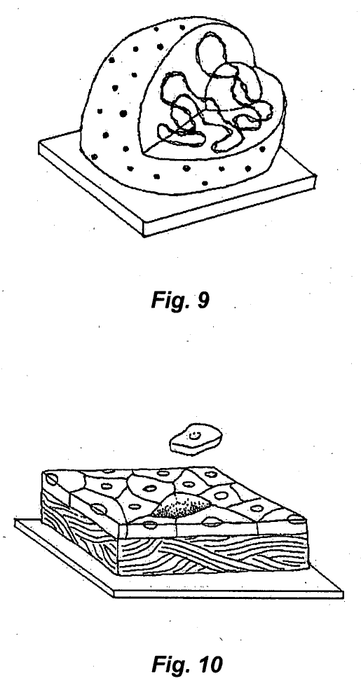

FIG. 9 is an illustration of an enlarged model representing a cell nucleus, supported on a wooden base, from which part of the nuclear envelope has been removed to, expose the nucleolus and the chromatin string. The part is supported on a wooden base.

FIG. 10 shows an enlarged model, in the form of a block, representing a section of simple squamous epithelial tissue, revealing the shape and arrangement of the cells and their respective nuclei. On the surface of the product one cell is removable, to permit an understanding if its irregular shape. The epithelial cells rest upon connecting tissue, between which there is an upstanding line representing the base membrane. The model is supported on a wooden base.

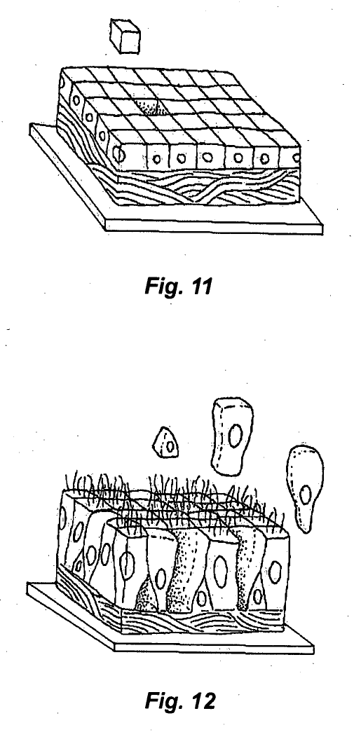

FIG. 11 shows an enlarged model, in the form of a block, representing a section of simple cuboidal epithelial tissue, revealing the arrangement of the cells and their nuclei. On the surface of the product, one cell is removable to permit an understanding of its shape. The epithelial cells rest upon connecting tissue, between which there is an upstanding line representing the base membrane. The model is supported on a wooden base.

FIG. 12 shows an enlarged model, in the form of a block, representing a section of simple ciliated pseudo stratified columnar epithelial tissue, revealing the arrangement of the cells and their nuclei. On the side of the product, it is possible to remove the three types of that constitute the structure shown, to permit an understanding of their respective shapes. The epithelial cells rest upon connective tissue between which there is an upstanding line representing the base membrane. The model is supported on a wooden base.

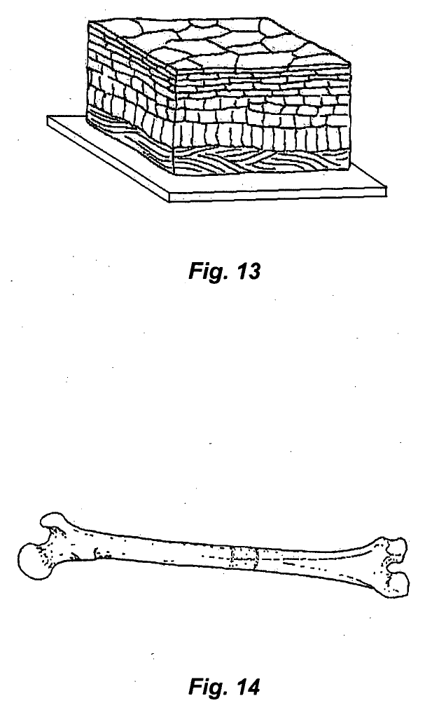

FIG. 13 shows an enlarged model, in the form of a block representing a section of non-keratinized stratified squamous epithelial tissue, revealing the variations of shape and the arrangement of its cells. The cells of the base layer rest on connective tissue, between which there is an upstanding line representing the base membrane. The model is supported on a wooden base.

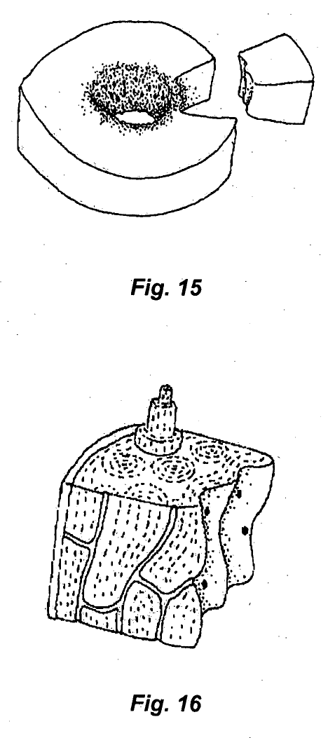

FIG. 14 shows a model representing a long bone—femur, with its ends (epiphyses) maintaining their shape and differentiating characteristics; the central region (diathesis) including a raised ring indicating the region of the section which is the next model (FIG. 15) to be studied. The model is supported on a wooden base.

FIG. 15 shows an enlarged model, in the form of a block, representing a cross section of the diathesis of the long bone—femur, revealing the (internally) spongy and (externally) compact tissues. The part shown in separate (removed section) represents the next model to be studied. The model is supported on a wooden base.

FIG. 16 shows an enlarged model, in the form of a block, representing details of the cross section the diathesis of the long bone—femur, revealing the histological constitution of the compact bone tissue, with tubes cut to indicate the Havers and Volkmann canals. At the upper part of the model it is possible to perceive Havers systems, with one of them in relief to permit an understanding of its make-up. Small oval cavities, organized in concentric positions, are represented by gaps where some bone cells are located. The model is supported on a wooden base.

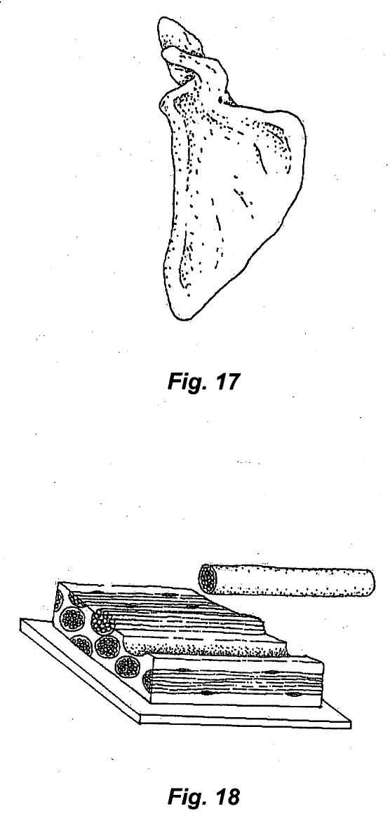

FIG. 17 shows an approximately life-size model representing a flat bone, a human shoulder-blade. The model is supported on a wooden base

FIG. 18 shows an enlarged model, in the form of a block, representing a section of thin striated muscle tissue, revealing the arrangement of the cells and their nuclei. On the surface of the model, it is possible to remove one cell to understand its shape; another cell at the surface of the model has its membrane pulled back to reveal the cytoplasm replete with specific filamentary structures, the myofibrils. The product is supported on a wooden base.

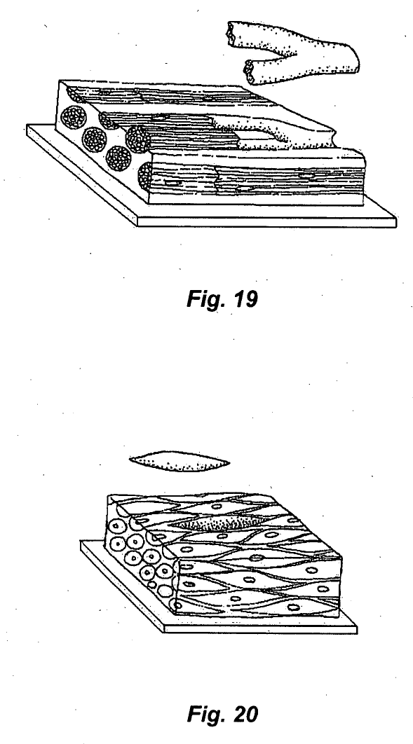

FIG. 19 shows, in block form, an enlarged model representing a section of striated cardiac muscle tissue, revealing the arrangement of the cells and their nuclei, one to two per cell. On the surface of the product, it is possible to remove one cell to appreciate its shape; on the surface is also found a cell without a membrane to reveal the internal structure (myofibrils). The product is supported on a wooden base.

FIG. 20 shows en bloc the product representing a section of smooth muscle tissue, revealing the arrangement of the cells and their nuclei. On the surface of the product, it is possible to remove one closed cell to appreciate its shape. The product is supported on a wooden base.

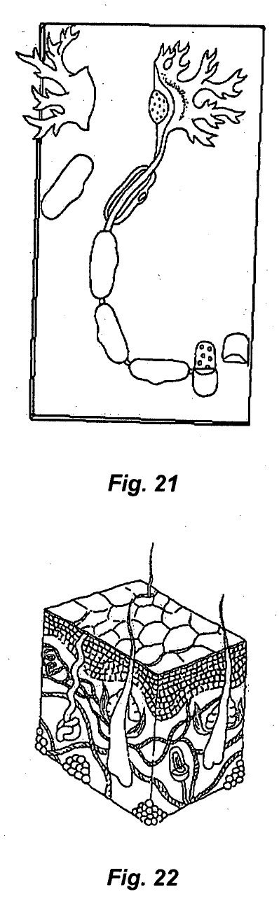

FIG. 21 shows an enlarged model representing a neuron, which is a cell of irregular shape having a body and extensions. A section through the cell body shows its internal nucleus. Another section along the nerve fiber shows the axon, one of the extensions of that cell. Yet another section at the dilated end, the synaptic area, shows small spherical structures corresponding to synaptic vesicles. When the sections are closed, they recompose the cell structure. The model is supported on a wooden base.

FIG. 22 shows, in the form of a block, a model representing a section of skin, revealing in detail the epidermis and the dermis, with their characteristics, apart from structures such as hairs and pili follicles, sebaceous glands, sudoriferous or sweat glands, and nerve ends that register touch. The model is supported on a wooden base.

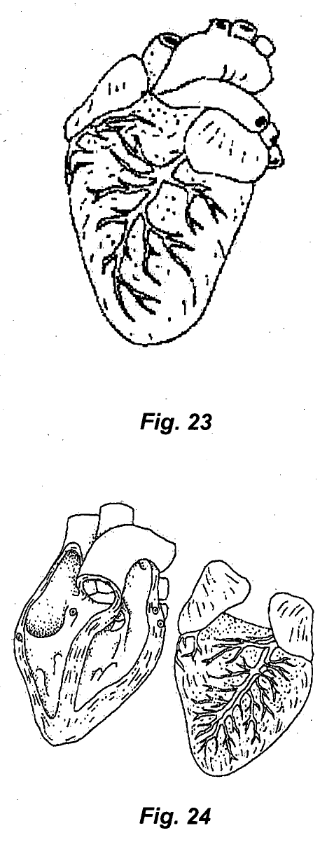

FIG. 23 shows an approximately life-sized model representing a heart, exposing the base veins and arteries. The model is supported on a wooden base.

FIG. 24 shows an enlarged model representing a heart with base veins and arteries. The section, divisions and textures distinguish the internal structures of the heart. The model is supported on a wooden base.

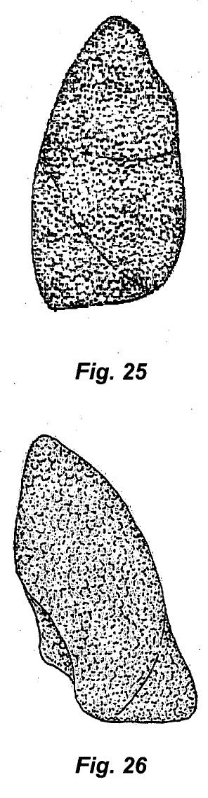

FIG. 25 shows an approximately life-sized model representing a left lung.

FIG. 26 shows an approximately life-sized model representing a right lung.

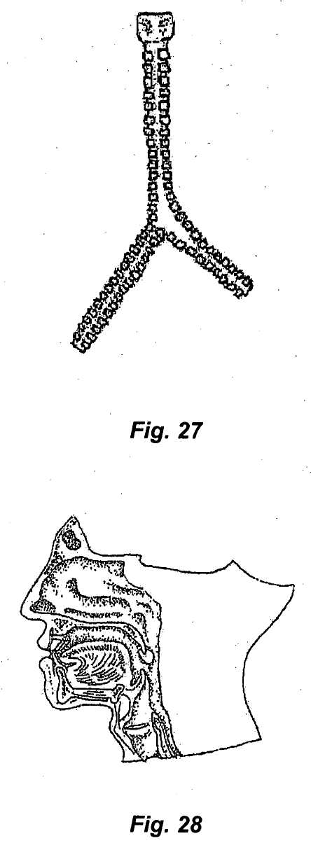

FIG. 27 shows an approximately life-sized model representing the trachea which is formed of cartilaginous rings, and of the left and right bronchial tubes. The model is supported on a wooden base.

FIG. 28 shows an approximately life-sized model representing a left paramedian section of the head, emphasizing the location and the different textures that characterize the upper respiratory tracts, leading from the wall of the left nasal cavity. The model is supported on a wooden base.

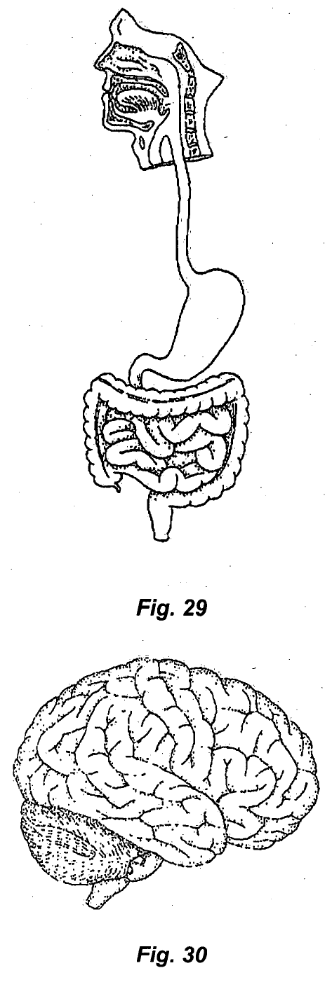

FIG. 29 shows an approximately life-sized model representing the complete digestive system, from the mouth, with its characteristic structures and textures, the pharynx and the esophagus as a long externally smooth tube. The stomach, which is externally smooth, includes a section accessing its rough internal structure in section. The attached organs are not represented. The model is supported on a wooden base.

FIG. 30 shows an approximately life-sized model representing a brain. Its surface includes the fissures (sulcus) and curls (gyrus) of the surface of the brain. The model is supported on a wooden base.

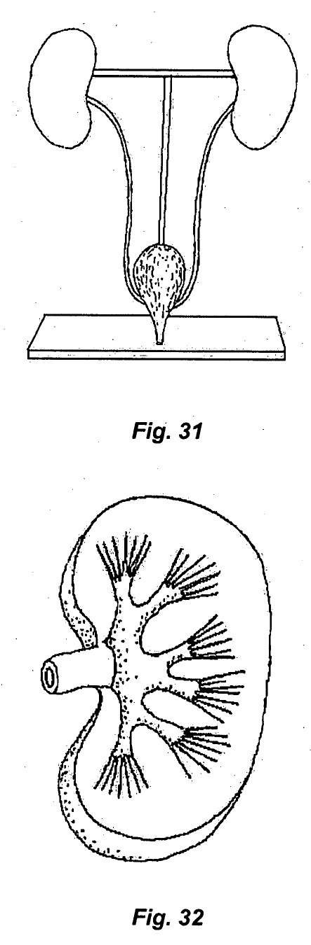

FIG. 31 shows an approximately life-sized model representing the urinary system, emphasizing all of its components with different textures. The model is supported on a wooden base.

FIG. 32 shows an enlarged model representing a median section of the kidney, revealing part of its internal structure and of the urethra. The model is supported on a wooden base.

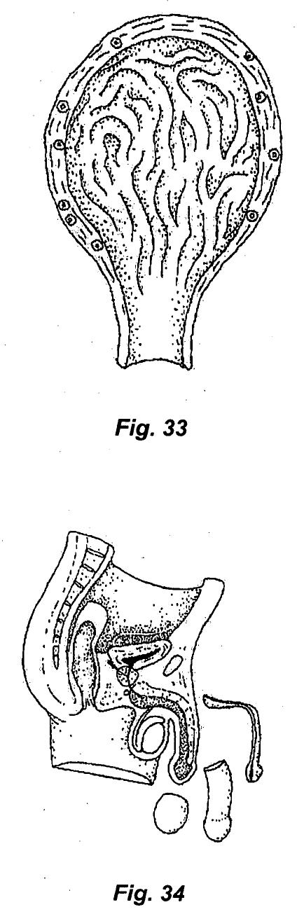

FIG. 33 shows an enlarged model representing a median section of the bladder. The model is supported on a wooden base.

FIG. 34 shows an almost life-size model of the male reproductive system (left side), in median sagittal section. The model permits differentiation between all of its internal and external components: the scrotal sac and penis being removable sections so as to show their internal structures. The model is supported on a wooden base.

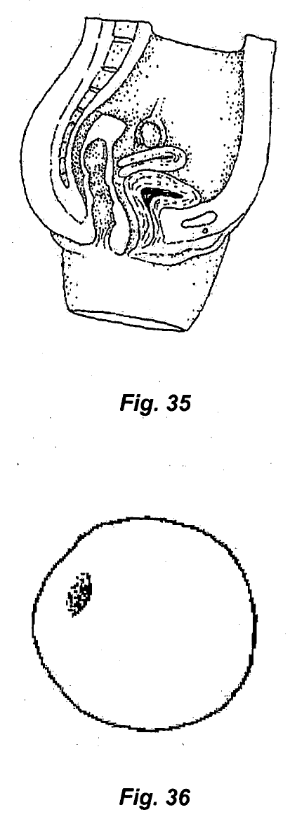

FIG. 35 shows an almost life-size model of the female reproductive system (left side) in median sagittal section. Different textures enable recognition of each internal and external component organ. The model is supported on a wooden base.

FIG. 36 shows a much enlarged model representing an ovum (female reproductive cell). The model is supported on a wooden base.

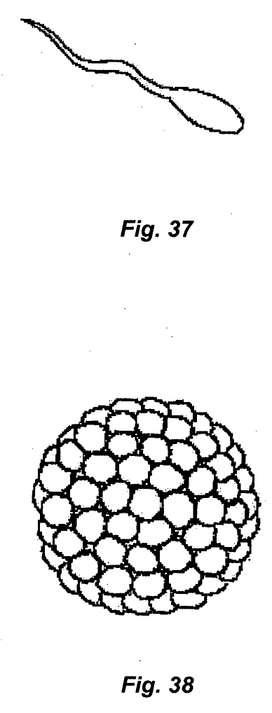

FIG. 37 shows a model representing a spermatozoon which is greatly enlarged to permit a differentiation between its body and tail.

FIG. 38 shows a model representing a morula, the initial phase of embryonic development. The part is constituted of an agglomerate of cells which are greatly enlarged. The model is supported on a wooden base.

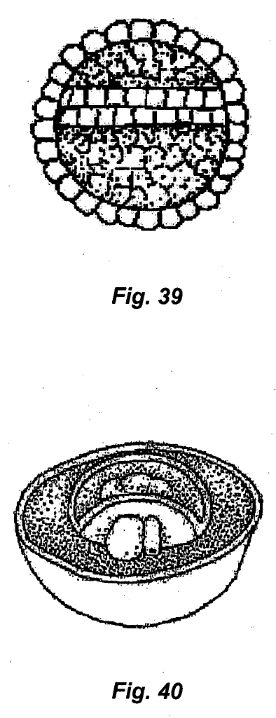

FIG. 39 shows a greater than life-sized model representing a blastocyst, one of the initial phases of embryonic development. The model is supported on a wooden base.

FIG. 40 shows an enlarged model representing a transversal section of a cylindrical embryo of approximately four weeks and of characteristic appearance. The model is supported on a wooden base.

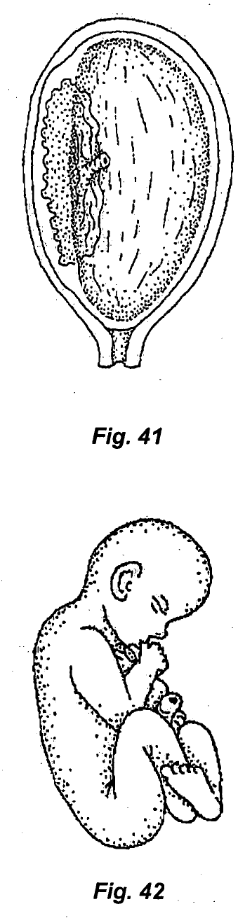

FIG. 41 shows an approximately life-sized model representing a median section of the uterus of a 38 week pregnancy, with its walls, and internal and external structures differentiated by texture. The model is supported on a wooden base.

FIG. 42 shows an almost life-sized model representing a 38 weeks male fetus, localized within the uterus, in the correct position for birth.

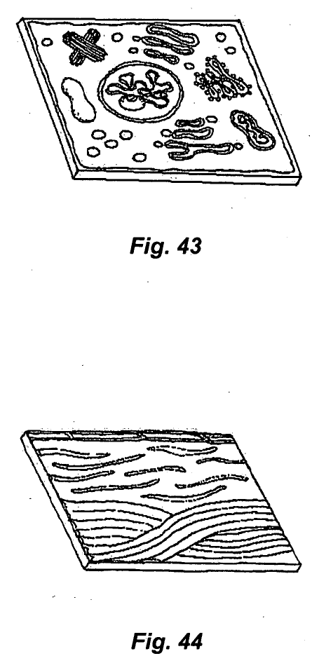

FIG. 43 shows a greatly enlarged relief model representing a spherical cell, with its main organelles.

FIG. 44 shows a greatly enlarged relief model representing a section of simple squamous epithelial tissue with its flattened and irregular cells and their elongated nuclei.

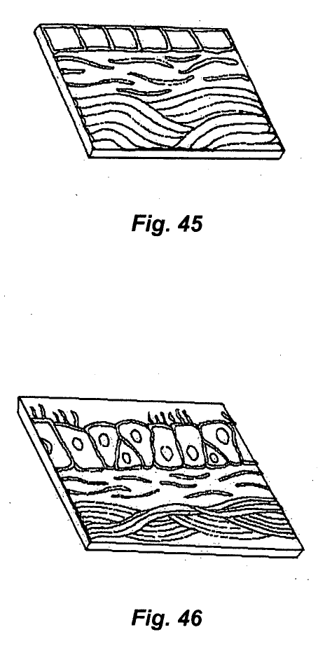

FIG. 45 shows a greatly enlarged relief model representing a section of simple cuboidal epithelial tissue, in greatly enlarged size.

FIG. 46 shows a greatly enlarged relief model representing a section of simple ciliated pseudostratified epithelial tissue with its three different and removable cell types.

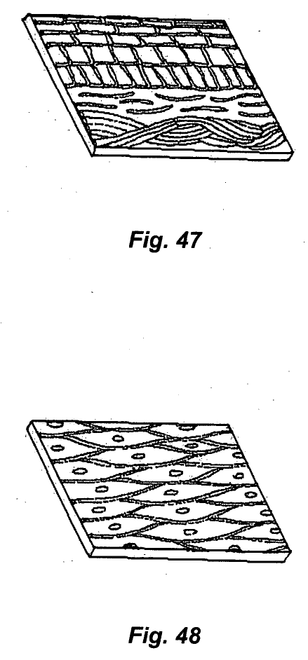

FIG. 47 shows a greatly enlarged relief model representing a section of non-keratinized stratified squamous epithelial tissue with its different cell structures.

FIG. 48 shows a greatly enlarged relief model representing a section of smooth muscle tissue with its elongated cells and their also elongated central nuclei.

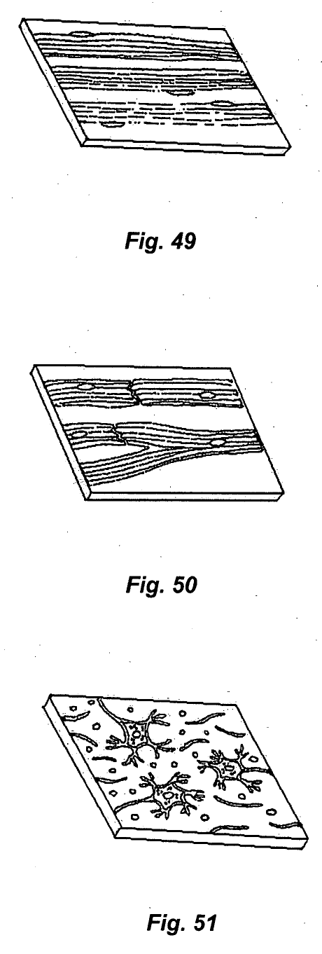

FIG. 49 shows a relief model representing a section of striated skeletal muscle tissue with its elongated cells and their peripherally positioned multiple nuclei, all the components being on a greatly enlarged scale.

FIG. 50 shows a greatly enlarged relief model representing a section of striated cardiac muscle tissue.

FIG. 51 shows a much enlarged relief model representing a section of nerve tissue and its cells, the neurons, showing the cell body with its central nucleus and its numerous extensions.

What we claim is:

1. A collection of models for facilitating the study of at least one of a biological subject, an anatomical organ and an anatomical organ system of a living being by students both with and without visual impairments;
(a) at least one base for supporting at least one model structure;
(b) at least one scientific or technical structure model to be studied as a whole by students both with and without visual impairments;
(c) at least one substructure model of a plurality of individual and optionally separable substructure models, which may be movably arranged with respect to one another in accordance with the corresponding relationship between each said substructure model and said structure model as and/or between said substructure models;
(d) an interpretative set for said models for facilitating the formation of images from an associative and enduring learning skills method by students both with and without visual impairments

2. A collection of models as claimed in claim 1, in which said at least one base for supporting said at least one structure model is made of a wooden material.

3. A collection of models as claimed in claim 1, in which said at least one scientific or technical structure model comprises a resistant and durable material for affording a learning procedure based on tactile perception.

4. A collection of models as claimed in claim 3, in which said resistant and durable material is selected from the group consisting of clay and plaster.

5. A collection of models as claimed in claim 1, in which said at least one substructure model comprises a material the texture of which simulates a respective one of a natural occurring biological subject, anatomical organ and anatomical organs system of a living being.

6. A collection of models as claimed in claim 5, in which said at least one substructure model comprises a material which simulates the color of a respective one of a natural occurring biological subject, anatomical organ and anatomical organs system of a living being.

7. A collection of models as claimed in claim 1, in which said interpretative set comprises:
(i) a first part in the form of a both printed and Braille informative description comprising a classical scientific and technological approach; and
(ii) a second part which comprises a detailed description in both printed and Braille form of each structure model or substructure models and the relationship between each said substructure model and said structure model and/or between said substructure models

8. A collection of models as claimed in claim 1, including a three-dimensional cell arrangement.

9. A collection of models as claimed in claim 8, in which said at least one substructure model of a plurality of individual and optionally separable substructure models is a part of said three-dimensional cell arrangement, each said substructure model being selected from the group consisting of:
a section of the rough endoplasmic reticulum;
a smooth endoplasmic reticulum;
a cross section of a Golgi body;
a cross section of a mitochondrion;
a whole mitochondrion in its closed form;
a pair of centrioles; and
a cell nucleus.

10. A collection of models as claimed in claim 1, in which said at least one substructure model of a plurality of individual and optionally separable substructure models corresponds to a Golgi body.

11. A collection of models as claimed in claim 1, in which said at least one substructure model of a plurality of individual and optionally separable substructure models of an epithelial tissue includes models selected from the group consisting of:
a section of a simple squamous epithelial tissue showing a disposition of cells including their nuclei;
a section of simple cuboidal epithelial tissue;
a section of simple ciliated-pseudo-stratified epithelial tissue; and
a section of a non-keratinized stratified squamous epithelial tissue.

12. A collection of models as claimed in claim 1, in which said at least one substructure model is at least one model of a tissue selected from the group consisting of:
a compact bone tissue showing the Hayers and Volkmann canals;
a section of a thin muscle tissue showing cells disposition including their nuclei;
a section of a striated cardiac muscle tissue showing cells disposition including their nuclei; and
a section of a smooth muscle tissue showing cells disposition including their nuclei.

13. A collection of models as claimed in claim 1, in which at least one of said structure and substructure models is selected from the group consisting of:
a femur;
a cross section of a femur showing spongy and compact tissue substructures; and
a flat bone represented by a scapula.

14. A collection of models as claimed in claim 1, in which said at least one substructure model represents a neuron including sections for showing its internal structures.

15. A collection of models as claimed in claim 1, in which said at least one substructure model represents a section of skin showing the organization of its layers.

16. A collection of models as claimed in claim 1, in which said at least one of said structure and substructure models represents at least one of the group consisting of:
a heart including base veins and arteries;
a section of a heart showing its internal structures including base veins and arteries;
left and right lungs as depicted;
trachea and bronchial tubes;
a left head paramedian section showing the left nasal cavity wall;
a digestive tube as depicted;
a brain;
an urinary system;
a kidney median section; and
a bladder median section.

17. A collection of models as claimed in claim 1, in which said at least one of said structure and substructure models represents at least one of the group consisting of:
a left side median sagittal section of the male reproductive system; and
a left side median sagittal section of the female reproductive system.

18. A collection of models as claimed in claim 1, in which said at least one of said structure and substructure models represents at least one of the group consisting of:
an ovum as depicted in FIG. 46; and
a spermatozoon as depicted in FIG. 47.

19. A collection of models as claimed in claim 1, in which said at least one of said structure and substructure models represents at least one of the group consisting of:
a morula as depicted;
a blastocyst;
a transverse section of an extra-embryonic and embryonic mesoderm showing a cylindrical embryo of approximately four weeks;
a median section of a uterus during pregnancy; and
a 38-week fetus.

20. A collection of models as claimed in claim 1, in which said structure models include an arrangement including at least one bi-dimensional structure model selected from the group consisting of:
a cell having its main parts in relief;
a section of a simple squamous epithelial tissue in relief;
a section of a simple cuboidal epithelial tissue in relief;
a section of a simple ciliated-pseudo-stratified epithelial tissue in relief;
a section of a non-keratinized stratified squamous epithelial tissue in relief;
a section of a smooth muscle tissue in relief;
a section of a striated skeletal muscle tissue in relief;
a section of a striated cardiac muscle tissue in relief; and
a section of a nerve tissue in relief.
